(19) United States
(12) Patent Application Publication
(10) Pub. No.: US 2010/0167177 A1
(43) Pub. Date: Jul. 1, 2010

(54) Carbon nanofiber with skin-core structure, method of producing the same, and products comprising the same

(75) Inventors: Kap Seung Yang, Gwangju (KR); Bo-Hye Hye Kim, Gwangju (KR); John P. Ferraris, Coppell, TX (US); Marilou dela Cruz, Richardson, TX (US)

Correspondence Address: THE NATH LAW GROUP, 112 South West Street, Alexandria, VA, 22314, US

(73) Assignees: INDUSTRY FOUNDATION OF CHONNAM NATIONAL UNIVERSITY, Gwangju-city (KR); BOARD OF REGENTS, THE UNIVERSITY OF TEXAS SYSTEM, Austin, TX (US)

(21) Appl. No.: 12/385,439

(22) Filed: Apr. 8, 2009

(30) Foreign Application Priority Data
Nov. 6, 2008 (KR) 10-2008-0110105

(51) Int. Cl. B01J 31/06; B29C 47/00; B32B 5/02; H01M 4/1393; H01G 9/058; H01G 9/155; H01G 9/048

(52) U.S. Cl. 429/532; 502/159; 264/465; 428/367; 361/502; 977/742; 977/762

(57) ABSTRACT

This invention relates to carbon nanofiber having a skin-core structure containing pitch and polyacrylonitrile, to a method of producing the carbon nanofiber, and to a product including the carbon nanofiber. The carbon nanofiber includes polyacrylonitrile and pitch having different properties respectively constituting a skin layer and/or a core layer, with a diameter of 1 μm or less, and thus functions of the carbon nanofiber vary depending on change in composition thereof.

### BACKGROUND OF THE INVENTION

1. Field of the Invention

The present invention relates to carbon nanofiber, and, more particularly, to carbon nanofiber having a skin-core structure containing pitch and polyacrylonitrile (PAN), a method of producing the same, and a product including the same.

2. Description of the Related Art

Typical examples of a precursor for carbon fiber include PAN, pitch, rayon and so on. Among these precursors, thorough research into PAN and pitch is conducted for industrialization purposes.

Specifically, a material able to produce carbon fiber through electrospinning should be highly soluble so as to maintain a viscosity adapted for forming fiber, and also should exhibit carbonization properties while producing aromatics rather than decomposition properties upon high-temperature heat treatment.

Examples of such a material include PAN, polyimide, polybenzoimidazole, pitch and so on. 90% or more of currently commercially available carbon fiber is PAN-based carbon fiber.

PAN is synthesized through copolymerization of acrylonitrile and a small amount of a monomer such as methylacrylate. Upon synthesis thereof, control of its molecular weight is regarded as important to determine the properties of the finally produced carbon fiber. Although PAN exhibits superior spinnability when electrospun and facilitates the production of fiber having a small diameter of about 200 nm, PAN has a low carbonization yield and hard graphitizing properties and thus manifests low crystallinity after heat treatment, resulting in poor electrical conductivity.

U.S. Pat. No. 4,323,525 and JP Unexamined Patent Publication No. Hei. 3-161502 disclose a method of producing fiber having a small diameter through electrostatic spinning. Also, Korean Unexamined Patent Publication No. 2002-0008227 discloses production of PAN-based carbon nanofiber through electrostatic spinning. Therein, the PAN solution is subjected to electrostatic spinning to thus be stabilized, carbonized and activated, thereby producing carbon nanofiber and activated carbon fiber. However, the PAN precursor is expensive, and the PAN-based carbon fiber has a low specific surface area and poor electrical conductivity, and thus limitations are imposed on exhibiting performance of an electrode for an electric double layer supercapacitor.

The production of the pitch-based carbon fiber depends on the properties of the pitch from which it is made. Typical carbon fiber is obtained from amorphous isotropic pitch, whereas high-modulus carbon fiber may be produced from anisotropic pitch. The pitch of petroleum and coal residue is composed mainly of an aromatic structure and has a molecular weight corresponding to that of an oligomer. Even when pitch is subjected to heat treatment under no tension, its strength is maintained and it has higher yield after carbonization, activation or graphitization and superior electrical conductivity and heat conductivity, compared to the PAN polymer based.

However, pitch has a low molecular weight and a planar molecular structure and may thus aggregate in solution, undesirably resulting in poor spinnability. Thus, pitch is disadvantageous because fiber is mainly produced through melt spinning or melt-blown spinning, and the diameter of the fiber from electrospinning thus obtained is relatively large.

Also, Korean Unexamined Patent Publication No. 10-2003-0002759 discloses production of pitch-based carbon nanofiber through electrospinning, including dissolving precursor pitch in a solvent, thus preparing a pitch solution which is then electrospun, followed by performing oxi-stabilization, carbonization and activation, thereby preparing a ultra-fine carbon fiber web and an activated carbon fiber web, but the diameter of the resultant fiber is relatively large due to poor spinnability.

Recently, with the goal of combining an electric double layer capacitor with a fuel cell to produce a power supply for an electrical vehicle requiring high output and high capacity, a lot of effort has been directed to using a nano carbon material as an electrode of an electric double layer capacitor or a fuel cell so that electrode performance is improved.

In this regard, Korean Unexamined Patent Publication No. 10-2002-0000163 discloses the production of carbon nanofiber through electrospinning and the fabrication of an electrode for an electric double layer capacitor. The development of the electrode for an electric double layer capacitor so as to simultaneously exhibit high energy density and high power density is under active study, but techniques satisfying the two properties at the same time have not yet been realized.

Korean Patent Application No. 10-2006-0048153 discloses a method of producing carbon nanofiber using a PAN/pitch solution blend in order to concurrently solve the problems of PAN such as a low specific surface area and a low carbonization yield and the problems of pitch such as low spinnability. However, this patent discloses just the production of bicomponent carbon fiber using the advantages of PAN and pitch, without disclosing the improved effects resulting from the fabrication of an electrode for an electric double layer capacitor using the above carbon fiber. The above carbon fiber is expected to improve the power density thanks to the combination of PAN and pitch but does not have the effect of obtaining a high energy density. Further, the size or depth of pores formed in the surface of the fiber cannot be controlled to an appropriate degree.

Moreover, in order to simultaneously exhibit high energy density and high power density, there has been research into controlling the size of pores for adsorbing ions. However, because the formation of pores having a desired size in the carbon material is based on an oxidation reaction, it is an expensive and time consuming process. Also, the method using a template makes it difficult to realize mass production at low cost, and the actual use thereof is thus impossible.

The major problem in the commercialization of a fuel cell is that the price of a catalyst is high and the durability of an electrode is poor. This is because heat is generated during the electrode reaction, and thus the catalyst is not maintained in the initial dispersion state but aggregates.

When this happens, voltage is lowered and the production of power stops. To solve these problems, a support should be highly conductive so that electrons produced in the catalyst are transported along a circuit at low resistance, and also should have a surface with high crystallinity so that it firmly supports the catalyst to thus prevent aggregation of the dispersed catalyst.

### SUMMARY OF THE INVENTION

The present inventors have directed their attention to the points that, in the production of carbon nanofiber through electrospinning using a blend of a PAN solution and a solution of a special kind of pitch fraction, when pitch having a very large molecular weight is used, separated phases which cannot be miscible into a single phase may be formed, and also, when a solvent having a low boiling point and low surface tension and being thus easily volatile is used as a solvent for dissolving the pitch, shallow pores may be formed in the surface of nanofiber, and thus have developed carbon nanofiber which is able to solve the problems of PAN and pitch encountered in the related art, and which simultaneously exhibits the high output and high capacitance of an electric double layer capacitor and manifests material properties suitable for use as the catalyst support of a fuel cell, thereby completing the present invention.

Accordingly, an object of the present invention is to provide carbon nanofiber which has a large specific surface area, shallow pores, high electrical conductivity and superior mechanical properties including compression resistance, and a method of producing the carbon nanofiber.

Another object of the present invention is to provide carbon nanofiber containing pitch, which is capable of being mass-produced simply and at low cost and which has improved spinnability and a diameter reduced to about 1/10 that of conventional fiber, and a method of producing the carbon nanofiber.

A further object of the present invention is to provide carbon nanofiber, which is configured such that PAN and pitch, each having properties different from the other, constitute a skin layer and/or a core layer respectively, and thus the functions of the carbon nanofiber vary depending on changes in the composition thereof, and a method of producing the carbon nanofiber.

Still a further object of the present invention is to provide carbon nanofiber, in which PAN and pitch such as to cause phase separation are respectively dissolved in solvents having different boiling points, and the mixed solvents having different boiling points are evaporated and removed from the fiber so that pores are formed, thus forming a large specific surface area without activation, and a method of producing the carbon nanofiber.

Still another object of the present invention is to provide a method of producing carbon nanofiber, in which the size and distribution of pores formed in the carbon nanofiber are controllable by changing a heating rate, the kind of solvent (e.g. tetrahydrofuran) used for dissolving the pitch, or the concentration thereof.

Yet another object of the present invention is to provide a carbon nanofiber which exhibits both high energy density and high power density at the same time so as to be adapted for use as an electrode material for an electric double layer capacitor, a catalyst support of a fuel cell, a gas diffusion layer of a fuel cell, a capacitive deionization electrode for use in converting seawater into freshwater, an ultrapure filter of the cooling water of a light-water reactor, and a highly conductive material, and products including the carbon nanofiber.

In order to accomplish the above objects, the present invention provides carbon nanofiber obtained by electrospinning a solution of PAN and pitch, the carbon nanofiber including a core composed of the pitch and a skin formed around the core and composed of a PAN homopolymer or copolymer.

In addition, the present invention provides carbon nanofiber obtained by electrospinning a solution of PAN and pitch, the carbon nanofiber including a core composed of a PAN homopolymer or copolymer, and a skin formed around the core and composed of the pitch.

Preferably, the solution of PAN and pitch is prepared by dissolving PAN and pitch in solvents having different boiling points.

Preferably, the pitch is a dimethylformamide (DMF) insoluble fraction obtained by fractionating the pitch using DMF.

Preferably, the pitch has a weight average molecular weight of 700˜5000 g/mol and solubility of 95% or more in a tetrahydrofuran (THF) solvent.

Preferably, the diameter of the carbon nanofiber including the core and the skin is 1 μm or less.

Preferably, the PAN copolymer includes itanoic acid or methylacrylate as a comonomer.

Preferably, the composition of the skin and the core varies depending on amounts of PAN and pitch.

In addition, the present invention provides a method of producing the carbon nanofiber, including dissolving PAN in a first solvent, thus preparing a first spinning solution, dissolving in a second solvent pitch having a molecular weight such that phase separation ensues upon blending with PAN, thus preparing a second spinning solution, blending the first spinning solution with the second spinning solution, thus preparing a third spinning solution, electrospinning the third spinning solution, thus preparing a carbon nanofiber precursor, and stabilizing the carbon nanofiber precursor, thus obtaining flame-resistant fiber.

Preferably, the second solvent has a boiling point lower than that of the first solvent.

Preferably, the first solvent and the second solvent are one or more selected from the group consisting of THF, DMF, DMAc (dimethylacetamide), pyridine, and quinoline.

Preferably, the method according to the present invention further includes subjecting the flame-resistant fiber to heat treatment at 900° C. or higher after stabilizing the carbon nanofiber precursor, thus obtaining the carbon nanofiber having a skin-core structure having different properties with a BET specific surface area of 300 m²/g or more.

In addition, the present invention provides an electric double layer capacitor, including, as an electrode, the above carbon nanofiber or the carbon nanofiber produced using the above method.

In addition, the present invention provides a fuel cell, including, as a catalyst support, the above carbon nanofiber or the carbon nanofiber produced using the above method.

Preferably, the carbon nanofiber as the catalyst support has a skin composed of pitch and a core composed of PAN.

### BRIEF DESCRIPTION OF THE DRAWINGS

The above and other objects, features and advantages of the present invention will be more clearly understood from the following detailed description taken in conjunction with the accompanying drawings, in which:

FIG. 1A shows an electron microscope image of electrospun PAN/pitch carbon nanofiber precursor fiber 1;

FIG. 1B shows an electron microscope image of electrospun PAN/pitch carbon nanofiber precursor fiber 2;

FIG. 2 shows a graph of differential thermal analysis of the PAN/pitch carbon nanofiber precursor fibers 1 and 2;

FIG. 3A shows a transmission electron microscope (TEM) image and a graph of an energy dispersive X-ray spectrometer (EDX) of PAN/pitch flame-resistant fiber 1;

FIG. 3B shows a TEM image and a graph of EDX of PAN/pitch flame-resistant fiber 2;

FIG. 4A shows a nitrogen adsorption isotherm of PAN/pitch carbon nanofiber obtained in the example of the present invention;

FIG. 4B shows a micropore distribution of the PAN/pitch carbon nanofiber;

FIG. 5A shows a TEM image of PAN/pitch graphitized fiber obtained by graphitizing the flame-resistant fiber 1 according to the present invention;

FIG. 5B shows a TEM image of PAN/pitch graphitized fiber obtained by graphitizing the flame-resistant fiber 2 according to the present invention;

FIG. 6 shows a graph of a Ragon plot of a carbon nanofiber electrode depending on the solubility of pitch in THF; and

FIG. 7 schematically shows end uses of the carbon nanofiber obtained by electrospinning the PAN/pitch solution blend.

### DESCRIPTION OF THE PREFERRED EMBODIMENTS

As the terms and words used in the present invention, those general terms and words currently being used with in the widest definitions have been selected. In special cases, used are the terms and words subjectively selected by the client, and these will be understood not according to their simple meanings but in consideration of the meaning described or used in the specification of the present invention.

Hereinafter, a detailed description will be given of the technical scope of the present invention with reference to the appended drawings and preferred embodiments.

Throughout the drawings, the same reference numerals are used to refer to the same or similar elements.

Among carbon fiber precursors, PAN exhibits superior spinnability upon electrospinning and facilitates production of nanofiber having a diameter of about 200 nm but has hard graphitizing properties. On the other hand, pitch has a high carbonization yield, a specific surface area much larger than that of PAN upon activation, and high electrical conductivity, but has poor spinnability and thus produces fiber having a large diameter of 3˜5 μm. In the present invention, PAN and pitch having the above properties are combined through electrospinning so that the advantages of each of the two precursors are exhibited.

In the present invention, a spinning solution containing PAN and a special kind of pitch is electrospun, thus forming PAN/pitch carbon nanofiber having a skin-core structure. In the case where PAN and pitch are blended, pitch having a molecular weight such as to cause phase separation is used and thus electrospinning is performed, thereby attaining carbon nanofiber configured such that the pitch is located in the skin and the PAN is located in the core. Ultimately, it is possible to produce superior carbon nanofiber having all of the advantages of PAN-based nanofiber and the advantages of pitch-based nanofiber.

Examples of the special kind of precursor pitch usable in the present invention include isotropic and anisotropic pitch obtained from coal tar or petroleum residue, and isotropic and anisotropic pitch obtained from organic compounds such as aromatic hydrocarbons. As mentioned above, in the case where the pitch is blended with PAN, pitch having a molecular weight such as to cause phase separation should be used. Preferably useful is pitch having a weight average molecular weight of 700˜5000 g/mol and solubility of 95% or more in THF. Also, in the case where the pitch is fractionated using DMF, a DMF insoluble fraction may be used.

Also, an example of fiber-forming PAN (Mw=160,000) includes modified acryl containing a 100% homopolymer and a 5˜15% copolymer. The composition of the copolymer may include itaconic acid or methylacrylate (MA) as a comonomer.

As a first solvent and a second solvent for dissolving PAN and pitch, one or more selected from among DMF, tetrachloromethane, toluene, THF, pyridine, and quinoline may be used depending on the degree of solubility of PAN and pitch in the solvent. In particular, the boiling point of the second solvent should be lower than that of the first solvent.

Specifically, PAN is dissolved in DMF selected as the first solvent, thus preparing a first spinning solution which is the PAN solution. Then, among isotropic precursor pitch and a DMF insoluble fraction obtained by fractionating pitch using DMF, pitch having a weight average molecular weight of 700˜5000 g/mol and solubility of 95% or more in a THF solvent is dissolved in THF selected as the second solvent, thus preparing a second spinning solution which is the pitch solution. As such, the first spinning solution and the second spinning solution may be prepared at the same time or in the reverse order. These first and second spinning solutions are blended, thus preparing a third spinning solution, which is then electrospun, thereby producing carbon nanofiber. The carbon nanofiber thus produced is in the form of PAN/pitch carbon nanofiber which has a skin-core structure composed of materials having different properties and in which the diameter thereof including the core and the skin is 1 μm or less. The second solvent, THF, has a boiling point lower than that of DMF used as the first solvent and thus evaporates at a lower temperature. Thereby, the depth of the pores of the carbonized pitch on the surface of the carbon nanofiber becomes shallower, and consequently, electrical conductivity and ion mobility are greatly increased.

The skin-core structure may have the core composed of the pitch and the skin formed around the core and composed of a PAN homopolymer or copolymer, or may have the core composed of a PAN homopolymer or copolymer and the skin formed around the core and composed of the pitch. In the skin-core structure, the composition of the skin and the core may vary depending on the amounts of PAN and pitch contained in the spinning solution.

In particular, when the pitch layer having high electrical conductivity and absorptivity is introduced into the skin, the resulting carbon nanofiber may have a large specific surface area and a shallow adsorption layer, and thus, upon use thereof as the electrode for an electric double layer capacitor, high specific capacity and fast response properties can be exhibited. Also, after graphitization, when the resulting carbon nanofiber is used as a catalyst support, a highly crystalline graphite structure well-developed in the skin can stably support the catalyst, can prevent the aggregation of the catalyst following extended use and can improve electrical conductivity, thus reducing resistance in the electrode.

A better understanding of the present invention may be obtained through the following examples which are set forth to illustrate, but are not to be construed to limit the present invention.

### Example 1

### 1. Preparation of Pitch

As the precursor pitch to be electrospun in the present invention, isotropic precursor pitch was used in its unaltered form. Alternatively, isotropic precursor pitch was dissolved in DMF and then fractionated into a DMF soluble fraction and a DMF insoluble fraction, after which the DMF insoluble fraction was separated from the DMF soluble fraction and used. Particularly useful was pitch having a weight average molecular weight of 700˜5000 g/mol and solubility of 95% or more in THF.

The properties of the pitch used for producing carbon nanofiber having a skin-core structure according to the present invention are shown in Table 1 below.

As is apparent from Table 1, the softening point, solubility and molecular weight of the pitch of the DMF insoluble fraction obtained by dissolving the petroleum-based isotropic precursor pitch in DMF to improve spinnability thereof and then filtering off the DMF soluble fraction, were measured and compared with those of the isotropic precursor pitch. The softening point was measured using a Mettler method, and the solubility was measured through GPC. In Table 1, HI indicates a hexane soluble fraction, TS indicates a toluene soluble fraction, TI indicates a toluene insoluble fraction, PS indicates a pyridine soluble fraction, and PI indicates a pyridine insoluble fraction.

TABLE 1

| | Softening | Molecular Weight | | | Solubility (%) | | | |
|---|---|---|---|---|---|---|---|---|
| | Point (° C.) | Mw | Mn | Mw/Mn | HI | TS | TI-PS | PI |
| Isotropic Precursor Pitch | 292 | 2229 | 349 | 6.38 | 96.8 | 61.9 | 38.1 | 0 |
| DMF Insoluble Fraction | 305 | 2380 | 368 | 6.46 | 71.2 | 59.2 | 40.8 | 0 |

### 2. Production of Carbon Nanofiber

Useful for production of carbon fiber, PAN and the above precursor pitch were respectively dissolved in THF and DMF, thus preparing first and second spinning solutions. The first and second spinning solutions were blended so that the ratio of PAN to precursor pitch was 50:50 wt %, thus preparing a third spinning solution 1. Separately, the first and second spinning solutions were blended so that the ratio of PAN to precursor pitch was 70:30 wt %, thus preparing a third spinning solution 2.

The third spinning solutions 1 and 2 which were blends of PAN and pitch were respectively electrospun, thus producing nonwoven fabric webs composed of nanofiber having a diameter of about 600˜800 nm, resulting in PAN/pitch spun fibers 1 and 2, namely, carbon nanofiber precursor fibers 1 and 2. As such, voltage of 30 kV was applied to each of the nozzle and the collector of the electrospinning device and the distance between the spinneret and the collector spaced apart from each other was changed in the range of about 10˜30 cm, depending on needs.

The PAN/pitch spun fibers 1 and 2 obtained through electrospinning were placed in a hot air circulation furnace, after which compressive air was supplied at a flow rate of 5˜20 ml/min. The fiber was stabilized while being maintained for 1 hour at 200˜300° C. at a heating rate of 1° C./min, thus obtaining PAN/pitch flame-resistant fibers 1 and 2.

The PAN/pitch flame-resistant fibers 1 and 2 were carbonized at 900° C. or higher and preferably 900˜1500° C. in an inert gas (N₂, Ar) atmosphere, thus producing PAN/pitch carbon nanofibers 1 and 2.

### Experimental Example 1

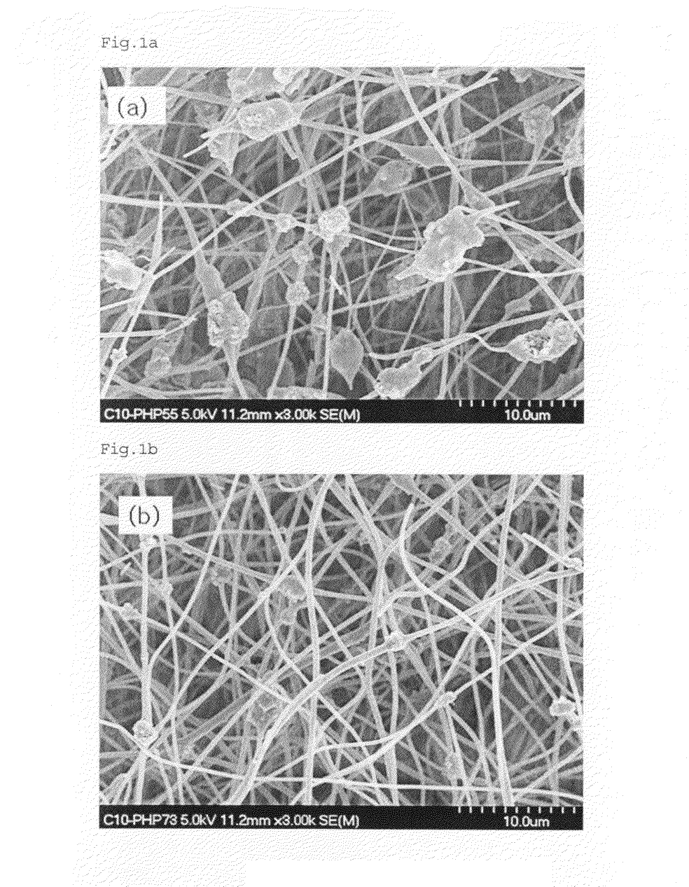

The structures of the carbon nanofiber precursor fibers 1 and 2 produced by respectively electrospinning the spinning solutions 1 and 2 in Example 1 were observed using an electron microscope. The results are shown in FIGS. 1A and 1B.

As seen in FIGS. 1A and 1B, as the amount of pitch in the spinning solution was reduced, spinnability was improved. In particular, in the case where the amount of pitch was 30 wt %, spinnability exhibited an improvement as a result of having reduced the material parameters (surface tension/viscosity) of the solution.

### Experimental Example 2

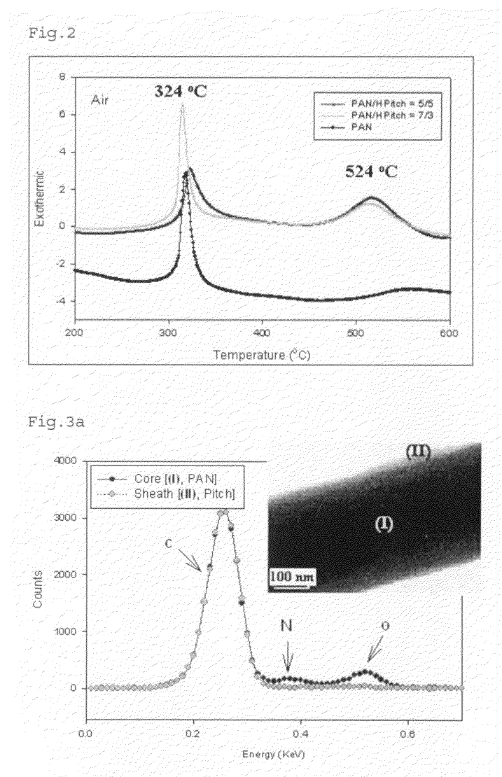

The carbon nanofiber precursor fibers 1 and 2, produced by respectively electrospinning the third spinning solutions 1 and 2 in Example 1, were subjected to differential thermal analysis. The results are shown in FIG. 2.

From the graph of FIG. 2, two intrinsic exothermic peaks of PAN and pitch were observed at 324° C. and 524° C., thus confirming thermal behavior of PAN and pitch separated from each other. At 324° C., the cyclization of PAN occurred, and at 524° C., the pitch was mainly carbonized, thus separating the heterogeneous element.

### Experimental Example 3

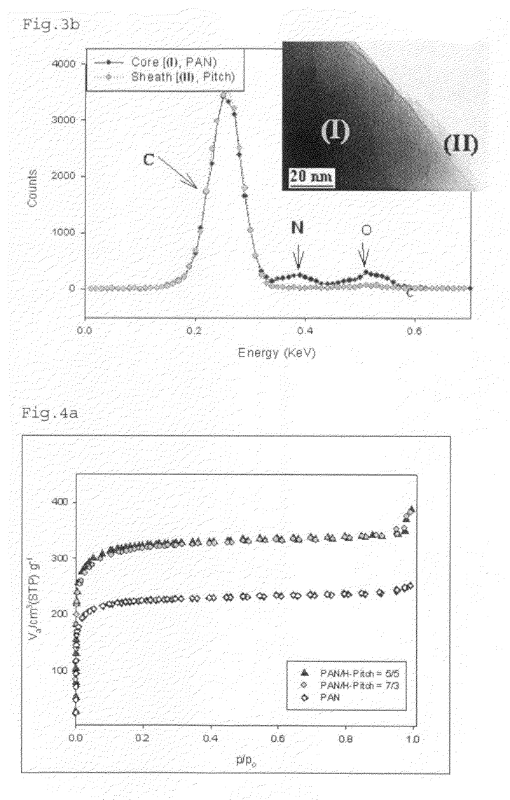

The PAN/pitch flame-resistant fibers 1 and 2 obtained by stabilizing the carbon nanofiber precursor fibers 1 and 2 in Example 1 were observed using TEM and EDX. The results are shown in FIGS. 3A and 3B.

As is apparent from the TEM images of FIGS. 3A and 3B, two phases were separated from each other. As results of observing two phases using EDX, in the core I of the flame-resistant fibers 1 and 2, the presence of nitrogen and oxygen was confirmed, and in the skin II, only carbon was confirmed. This flame resistance was obtained by diffusing oxygen from the air into the fiber so that oxygen was condensed with the heterogeneous element to thus cyclize PAN or form a network, resulting in flame-proofness. Nitrogen and oxygen were present in the core of the fiber composed of PAN, whereas the molecular structure of the pitch of the skin contained neither nitrogen nor oxygen by virtue of having dehydrated the diffused and adsorbed oxygen with hydrogen in the pitch molecule at a flame-resistant temperature, thus eliminating it. Thereby, the PAN containing nitrogen was located in the core, while the pitch was located in the skin. Ultimately, the carbon nanofiber according to the present invention could be seen to have a skin-core structure composed of materials having different properties.

### Experimental Example 4

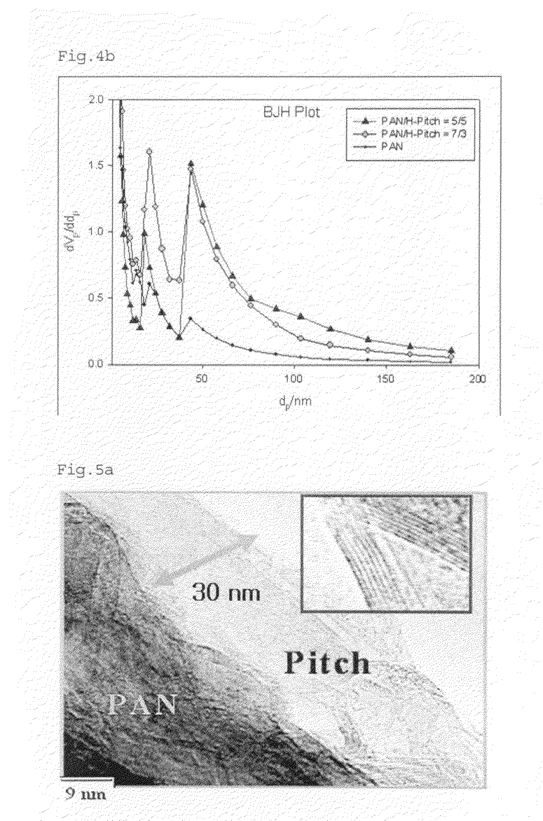

To evaluate pore properties of the PAN/pitch carbon nanofibers 1 and 2 obtained by carbonizing the PAN/pitch flame-resistant fibers 1 and 2 in Example 1 at 1000° C. in an inert gas (N₂, Ar) atmosphere without activation, the nitrogen adsorption isotherm and mesopore distribution were observed. The results are shown in FIGS. 4A and 4B.

In the nitrogen adsorption isotherm of FIG. 4A, typical type I in which initial adsorption was large was represented under a relative pressure of 0.2 atm or less. In the mesopore distribution of FIG. 4B, in the case of PAN/pitch 70/30 wt % having low pitch content, namely, the flame-resistant fiber 2, the mesopores were seen to be further developed.

The BET specific surface area, pore volume, and average pore size of the fiber carbonized from the PAN/pitch flame-resistant fibers 1 and 2 are shown in Table 2 below. As is apparent from Table 2, the BET specific surface area, the pore volume, and the average pore size can be seen to be increased in inverse proportion to a decrease in the amount of pitch.

TABLE 2

| | BET | Pore | Average |
|---|---|---|---|
| | Surface | Volume | Pore |
| | Area (m²/g) | (cm³/g) | Size (Å) |
| PAN/Pitch Carbonized Fiber 1 | 304 | 0.275 | 12.0 |
| PAN/Pitch Carbonized Fiber 2 | 770 | 0.310 | 16.0 |

Further, in the case of PAN/pitch 70/30 wt %, the BET specific surface area, the pore volume, and the average pore size depending on the concentration of pitch dissolved in THF were increased in inverse proportion to a decrease in the concentration of the pitch (in proportion to an increase in the amount of THF) as shown in Table 3 below.

TABLE 3

| | Conc. of Pitch | BET | Pore | Average |
|---|---|---|---|---|
| | dissolved in | Surface | Volume | Pore |
| | THF (wt %) | Area (m²/g) | (cm³/g) | Size (Å) |
| PAN/Pitch | 50 | 769.8 | 0.310 | 16.0 |
| 70/30 wt % | 40 | 820.3 | 0.332 | 16.3 |
| | 30 | 856.97 | 0.358 | 16.7 |
| | 20 | 917.85 | 0.386 | 16.8 |

### Experimental Example 5

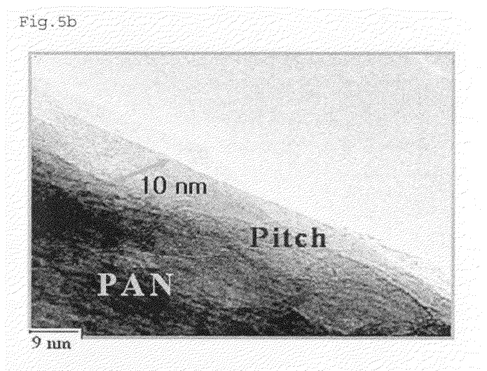

To evaluate phase dispersion and crystallinity of PAN and pitch, PAN/pitch graphitized fibers 1 and 2 obtained by graphitizing the PAN/pitch flame-resistant fibers 1 and 2 of Example 1 at 2800° C. in an Ar gas atmosphere were observed using TEM. The results are shown in FIGS. 5A and 5B.

As is apparent from the TEM images of FIGS. 5A and 5B, it can be seen that the graphitized fibers 1 and 2 had a skin-core structure such that the skin having a high crystalline layer and the core having a low crystalline layer were phase-separated from each other. The thickness of the skin was increased in proportion to the increase in the concentration of the pitch.

### Example 2

Electric double layer capacitors 1 and 2 were respectively fabricated using the PAN/pitch carbon nanofibers 1 and 2 of Example 1.

### Experimental Example 6

The charge/discharge capacities of the capacitors 1 and 2 of Example 2 were measured. The results are shown in Table 4 below.

For measurement, as an electrolyte, KOH and H₂SO₄ solutions which are aqueous solution electrolytes, and EMIIm bis(trifluorosulfonyl)imide) which is an ionic liquid were used. The charge/discharge voltage was 0˜1 V in the case of the aqueous solution electrolyte, and was 0˜3 V in the case of the ionic liquid.

As is apparent from Table 4 showing the charge/discharge capacities in respective electrolytes, the capacitor 2 including the carbon nanofiber 2 produced using the PAN/pitch spinning solution at 70/30 wt % had an energy density of 7.50 Wh/kg and a power density of 12500 W/kg in the ionic liquid, and thus could be seen to exhibit high energy density and high power density at the same time.

TABLE 4

| | Highest Energy | | Highest Power | |
|---|---|---|---|---|
| | Density (Wh/kg) | | Density (W/kg) | |
| Electrolyte | Capacitor 1 | Capacitor 2 | Capacitor 1 | Capacitor 2 |
| 30% KOH | 0.73 | 6.04 | 1415 | 3947 |
| 3 M H₂SO₄ | 1.42 | 6.71 | 2500 | 4165 |
| EMIIm | 3.79 | 7.50 | 7500 | 12500 |

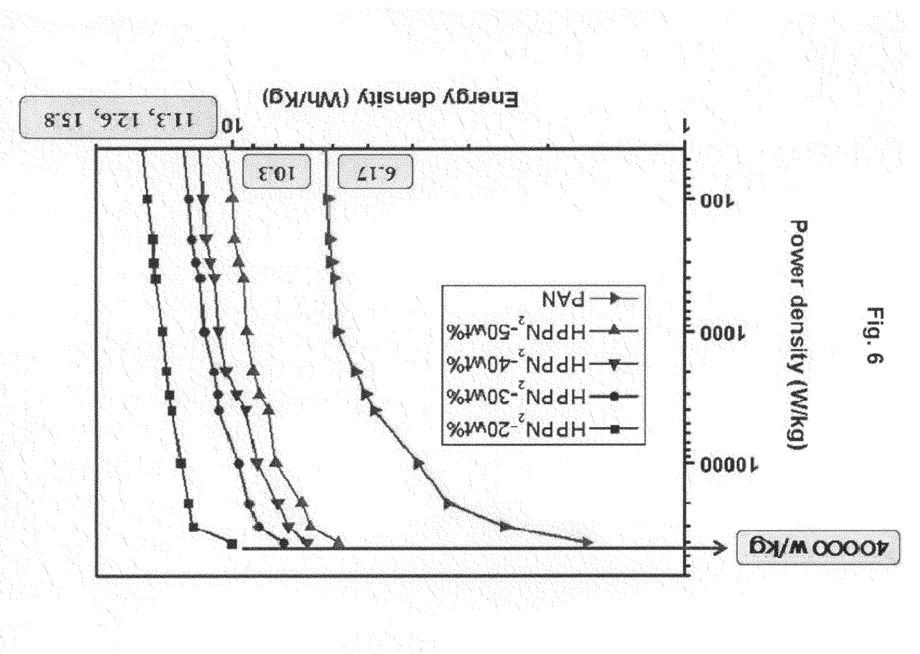

FIG. 6 shows a Ragon plot of the carbon nanofiber electrode obtained by changing the concentration of pitch dissolved in THF. In a 6 M aqueous KOH electrolyte solution, the capacitor showed capacitance of 130 F/g, energy density of 16.5 Wh/kg, and power density of 40 kw/kg, thus exhibiting high energy density and high power density at the same time. Because THF which is the pitch solvent has a boiling point and surface tension lower than those of DMF which is the PAN solvent, it is easily volatile, thus forming shallow pores in the fiber surface, resulting in superior electrical and physical properties. Through the selection of the solvent or the change in the concentration of the solvent, the pore size and depth of the carbon nanofiber can be efficiently controlled. Thus, high energy density and power density properties can be advantageously exhibited at the same time.

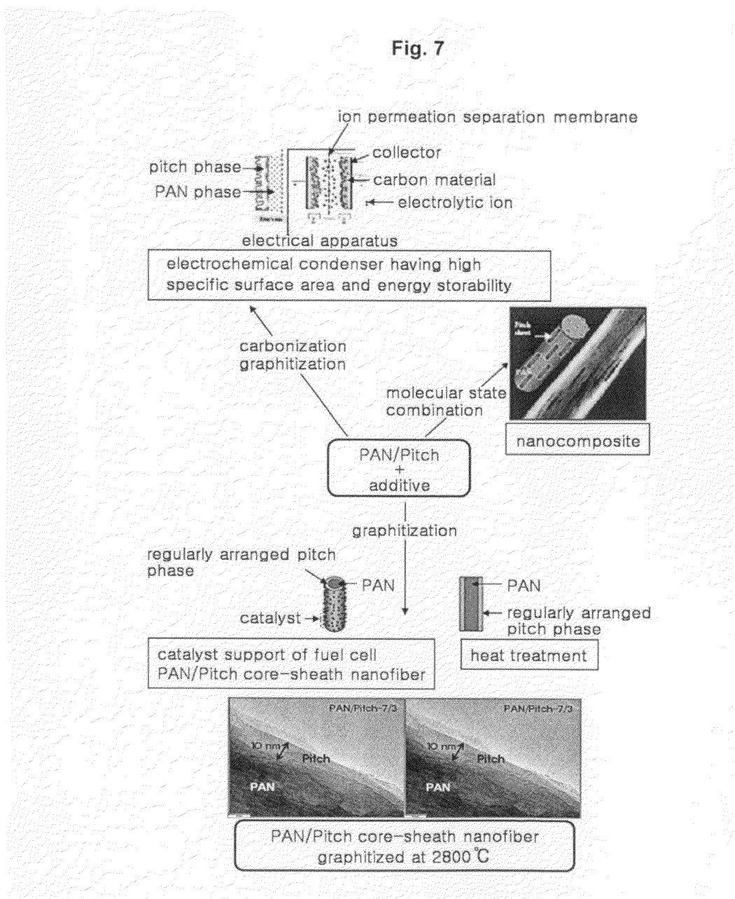

As shown in FIG. 7, the carbon nanofiber according to the present invention can be used for various purposes. In particular, in the case where the carbon nanofiber is used as an electric double layer capacitor electrode or a catalyst support, it has a large specific surface area to thus attain high storage energy density, has shallow pores and high electrical conductivity to thus exhibit fast response properties, and also has good mechanical properties to thus result in high workability and durability. When the material having the above properties is used for the electric double layer capacitor electrode, as in Experimental Example 6, high energy density and high power density can be exhibited at the same time.

In the skin of the fiber having the skin-core structure, the pitch layer having a well-developed graphite structure may be located, and in the core, the PAN layer having low crystallinity may be located. In this case, a highly crystalline graphite structure well-developed in the skin can stably support the catalyst, can prevent the aggregation of the catalyst following extended use, and can improve electrical conductivity, thus reducing resistance in the electrode. Therefore, the carbon nanofiber is suitable for use as the support of the fuel cell.

As described above, the present invention provides carbon nanofiber with a skin-core structure, a method of producing the same and a product including the same. According to the present invention, the following effects can be obtained.

Specifically, the carbon nanofiber according to the present invention has a large specific surface area, shallow pores, high electrical conductivity and superior mechanical properties including compression resistance.

In addition, the method of producing the carbon nanofiber according to the present invention provides pitch-containing carbon nanofiber having improved radioactivity and having a diameter reduced to about 1/10 that of conventional fiber.

In addition, because the carbon nanofiber according to the present invention is configured such that PAN and pitch each having properties different from the other constitute a skin layer and/or a core layer respectively, functions thereof become varied depending on changes in the composition thereof.

In addition, the method of producing the carbon nanofiber according to the present invention involves dissolving PAN and pitch respectively in solvents having different boiling points to induce phase separation, and thus evaporates and removes the mixed solvents having different boiling points from the fiber so that pores are formed, thereby forming a large specific surface area without performing activation. Also, the size and distribution of the pores formed in the carbon nanofiber can be controlled by changing a heating rate, the kind of solvent (THF) for dissolving the pitch or the concentration thereof. Thereby, the method according to the present invention simplifies a production process and reduces the production cost.

In addition, the carbon nanofiber according to the present invention exhibits high energy density and high power density at the same time and thus can be adapted for use as an electrode material for an electric double layer capacitor, a catalyst support of a fuel cell, a gas diffusion layer of a fuel cell, a capacitive deionization electrode for converting seawater into freshwater, an ultrapure filter of the cooling water of a light-water reactor, and a highly conductive material.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A carbon nanofiber obtained by electrospinning a solution of polyacrylonitrile and pitch, the carbon nanofiber comprising:
a core comprising the pitch; and
a skin formed around the core and comprising a polyacrylonitrile homopolymer or copolymer.

2. A carbon nanofiber obtained by electrospinning a solution of polyacrylonitrile and pitch, the carbon nanofiber comprising:
a core comprising a polyacrylonitrile homopolymer or copolymer; and
a skin formed around the core and comprising the pitch.

3. The carbon nanofiber as set forth in claim 1, wherein the solution of polyacrylonitrile and pitch is prepared by dissolving the polyacrylonitrile and the pitch in solvents having different boiling points.

4. The carbon nanofiber as set forth in claim 1, wherein the pitch is a dimethylformamide insoluble fraction obtained by fractionating the pitch using dimethylformamide.

5. The carbon nanofiber as set forth in claim 1, wherein the pitch has a weight average molecular weight of 700˜5000 g/mol and solubility of 95% or more in a tetrahydrofuran solvent.

6. The carbon nanofiber as set forth in claim 1, wherein a diameter of the carbon nanofiber including the core and the skin is 1 μm or less.

7. The carbon nanofiber as set forth in claim 1, wherein a composition of the skin and the core varies depending on amounts of the polyacrylonitrile and the pitch.

8. The carbon nanofiber as set forth in claim 1, wherein the skin comprises a plurality of pores having a size and a distribution that is controlled depending on changes in a heating rate, a kind of solvent for dissolving the pitch, or a concentration of the solvent.

9. A method of producing a carbon nanofiber, the method comprising:
dissolving polyacrylonitrile in a first solvent, thus preparing a first spinning solution;
dissolving in a second solvent pitch having a molecular weight such that phase separation ensues upon blending with the polyacrylonitrile, thus preparing a second spinning solution;
blending the first spinning solution with the second spinning solution, thus preparing a third spinning solution;
electrospinning the third spinning solution, thus preparing a carbon nanofiber precursor; and
stabilizing the carbon nanofiber precursor, thus obtaining a flame-resistant fiber.

10. The method as set forth in claim 9, wherein the second solvent has a boiling point lower than that of the first solvent.

11. The method as set forth in claim 10, wherein the first solvent and the second solvent are each one or more members selected from the group consisting of tetrahydrofuran, dimethylformamide, dimethylacetamide, pyridine, and quinoline.

12. The method as set forth in claim 9, further comprising subjecting the flame-resistant fiber to heat treatment at 900° C. or higher after stabilizing the carbon nanofiber precursor, thus obtaining the carbon nanofiber having a skin-core structure having different properties with a BET specific surface area of 300 m²/g or more.

13. An electric double layer capacitor, comprising an electrode comprising the carbon nanofiber of claim 1.

14. A fuel cell, comprising a catalyst support comprising the carbon nanofiber of claim 1.

15. The fuel cell as set forth in claim 14, wherein the carbon nanofiber comprises a skin comprising pitch and a core comprising polyacrylonitrile.

16. An electric double layer capacitor, comprising an electrode comprising the carbon nanofiber produced by the method set forth in claim 9.

17. A fuel cell, comprising a catalyst support comprising the carbon nanofiber produced by the method as set forth in claim 9.

18. The fuel cell as set forth in claim 17, wherein the carbon nanofiber comprises a skin comprising pitch and a core comprising polyacrylonitrile.
